(19) United States
(12) Patent Application Publication
(10) Pub. No.: US 2014/0289806 A1
(43) Pub. Date: Sep. 25, 2014

(54) METHOD, APPARATUS AND ELECTRONIC DEVICE FOR ENABLING PRIVATE BROWSING

(71) Applicant: TENCENT TECHNOLOGY (SHENZHEN) COMPANY LIMITED, Shenzhen (CN)

(72) Inventors: Huijiao YANG, Shenzhen (CN); Tingyong TANG, Shenzhen (CN); Renfang LIU, Shenzhen (CN); Bo HU, Shenzhen (CN); Zhipei WANG, Shenzhen (CN); Ruiyi ZHOU, Shenzhen (CN); Xi WANG, Shenzhen (CN); Zhengkai XIE, Shenzhen (CN); Bosen HE, Shenzhen (CN); Ying HUANG, Shenzhen (CN); Wei LI, Shenzhen (CN); Cheng FENG, Shenzhen (CN); Kai ZHANG, Shenzhen (CN); Yulei LIU, Shenzhen (CN)

(73) Assignee: TENCENT TECHNOLOGY (SHENZHEN) COMPANY LIMITED, Shenzhen (CN)

(21) Appl. No.: 14/194,404

(22) Filed: Feb. 28, 2014

Related U.S. Application Data
(63) Continuation of application No. PCT/CN2013/088231, filed on Nov. 29, 2013.

(30) Foreign Application Priority Data
Mar. 19, 2013 (CN) 201310088230.3

(51) Int. Cl. H04L 29/06

(52) U.S. Cl. CPC H04L 63/08
USPC 726/4; 726/27

(57) ABSTRACT

The present disclosure discloses a method, apparatus, browser, electronic device and computer readable storage medium for enabling private browsing, and belongs to the field of computer technology. The method includes receiving user identification information for enabling a private browsing mode of the browser; checking whether the user identification information is matched with the prestored user identification information; and enabling the private browsing mode of the browser if the checking result is that the user identification information is matched with a prestored user identification information. By setting the user identification information for the private browsing mode of the browser, the private browsing mode of the browser can be used only when a legitimate user inputs the correct user identification information, thereby it is avoided that other users perform operations which infringe on the legitimate user's rights and interests or privacy, so that security risks are greatly reduced.

### CROSS-REFERENCES TO RELATED APPLICATIONS

This application is a continuation of International Application No. PCT/CN2013/088231, filed on Nov. 29, 2013, which claims priority to Chinese patent application No. CN201310088230.3 named “Method, Apparatus, Browser and Electronic Device for Enabling Private Browsing” and filed on Mar. 19, 2013, the disclosure of which is incorporated herein by reference in its entirety.

### TECHNICAL FIELD

The present disclosure relates generally to the field of computer technology, and in particular to a method, apparatus and electronic device for enabling private browsing.

### BACKGROUND

As the current requirement of the privacy of a browsing behavior by users is increasing, numerous browsers are designed with a private browsing mode. In such a private browsing mode, the browser does not record information such as a network browsing record, an input history and so on.

In accordance with such a private browsing mode, the prior art provides a method for enabling private browsing, including the following steps; a private browsing mode is set on a browser, and a user clicks the private browsing mode; the browser enters the private browsing mode, and the browser does not record information such as a web page browsing record, an input history, a cookie and so on of the user when the user browses web pages through the browser having entered the private browsing mode. However, there are great security risks in the private browsing mode of a browser in the prior art.

### SUMMARY OF THE INVENTION

To resolve the problem that there are great security risks in the private browsing mode of a browser in the prior art, embodiments of the present disclosure provide a method, apparatus, browser, electronic device and computer readable storage medium for enabling private browsing.

In a first aspect of the present disclosure, a method is provided for enabling private browsing, which is applied to an electronic device containing a browser; the method comprising receiving a user identification information for enabling a private browsing mode of the browser; checking whether the user identification information is matched with a prestored user identification information; and enabling the private browsing mode of the browser if the checking result is that the user identification information is matched with the prestored user identification information.

In a second aspect of the present disclosure, an apparatus is provided for enabling private browsing, which is applied to an electronic device containing a browser, the apparatus comprising a first reception module configured to receive a user identification information for enabling a private browsing mode of the browser; a first checking module configured to check whether the user identification information received by the first reception module is matched with the prestored user identification information; and an enabling module configured to enable the private browsing mode of the browser if the checking result of the first checking module is that the user identification information is matched with the prestored user identification information.

In a third aspect of the present disclosure, there is provided an electronic device containing a browser, the electronic device comprising the apparatus for enabling private browsing provided in the second aspect.

In a fourth aspect of the present disclosure, there is provided a browser, comprising the apparatus for enabling private browsing provided in the second aspect.

In a fifth aspect of the present disclosure, there is provided a computer readable storage medium having stored thereon a computer program containing a program code which, when executed on a computing device, performs respective steps of the method for enabling private browsing in the first aspect.

The technical solutions provided by embodiments of the present disclosure bring about beneficial effects that by setting the user identification information for the private browsing mode of a browser, the private browsing mode of the browser can be used only when a legitimate user inputs a correct user identification information, and other users can only use an open browsing mode of the browser, thereby it is avoided that other users perform operations which infringe on the legitimate user's rights and interests or privacy through the private browsing mode of the browser, so that security risks are greatly reduced.

### BRIEF DESCRIPTION OF THE DRAWINGS

In order to explain technical solutions in embodiments of the present disclosure more clearly, simple introduction of attached drawings needed to be used in the description of the embodiments will be given below. Apparently, the attached drawings in the description below are only some of the embodiments of the present disclosure. For those ordinary skilled in the art, other attached drawings can be obtained according to these attached drawings without inventive efforts.

FIG. 1 is a flowchart of a method for enabling private browsing provided in a first embodiment of the present disclosure;

FIG. 2 is a flowchart of a method for enabling private browsing provided in a second embodiment of the present disclosure;

FIG. 3 is a schematic diagram of inputting the user identification information in one embodiment of the present disclosure;

FIG. 4 is a schematic diagram of inputting the user identification information in another embodiment of the present disclosure;

FIG. 5 is a schematic diagram of inputting the user identification information in a further embodiment of the present disclosure;

FIG. 6 is a flowchart of a method for enabling private browsing provided in a third embodiment of the present disclosure;

FIG. 7 is a structural schematic diagram of an apparatus for enabling private browsing provided in a fourth embodiment of the present disclosure;

FIG. 8 is a structural schematic diagram of an apparatus for enabling private browsing provided in a fifth embodiment of the present disclosure;

FIG. 9 is a structural schematic diagram of an apparatus for enabling private browsing provided in a sixth embodiment of the present disclosure; and

FIG. 10 is a structural schematic diagram showing an exemplary electronic device which can be used to implement respective embodiments of the present disclosure.

### DETAILED DESCRIPTION

In order to make the object, technical solutions and advantages of the present disclosure more clear, a further detailed description of implementations of the present disclosure will be made in conjunction with the attached drawings below.

The “electronic device” described herein includes, but is not limited to, desktop computers, notebooks, smart phones, tablet computers, E-book reader and so on.

The term “private browsing mode” described herein refers to a browsing mode in which the information related to a user's browsing behaviour is recorded in order to protect the privacy of the user's browsing behaviour. The information can include, but is not limited to, part or all of the web page browsing record, the input history, the cookie, and so on. That information which is not to be recorded in the private browsing mode can be configured depending on specific application scenarios. In addition, the term “private browsing mode” and the term “private browsing” are exchangeable herein unless the context indicates otherwise.

In the procedure of implementing the present disclosure, the inventor finds that there are great security risks in the private browsing mode of a browser in the prior art. For example, after other users borrow an owner user's electronic device, they may browse web pages through a private browsing mode of a browser in the electronic device. Since the corresponding browsing record is not recorded in the private browsing mode of the browser, said other users may perform any operations in the private browsing mode, such as online payment, browsing and so on, even including operations, which infringe on the owner user's rights and interests or privacy. However, the owner user fails to know which user performs an operation, which infringes on the owner user's rights and interests or privacy, and which operations that infringe on the owner user's rights and interests or privacy are performed by other users. Thus, there are great security risks.

### First Embodiment

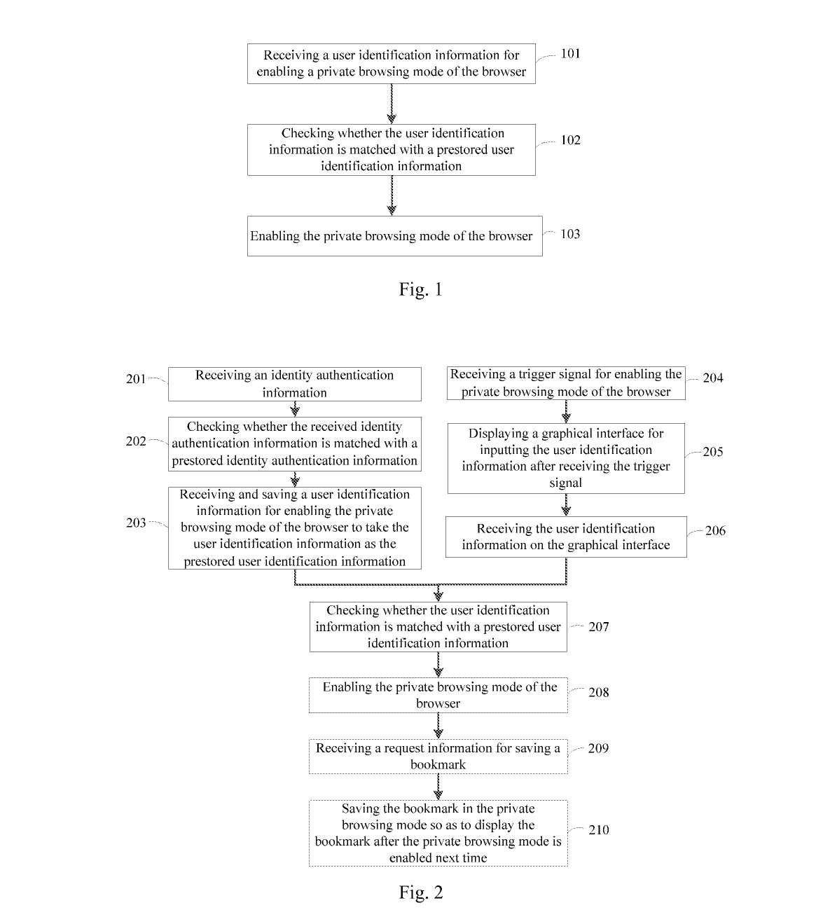

Please refer to FIG. 1, which shows a flowchart of a method for enabling private browsing provided in the first embodiment of the present disclosure. The method for enabling private browsing can be applied to an electronic device containing a browser. The method for enabling private browsing may include the flowing steps 101-103.

At step 101, user identification information for enabling a private browsing mode of the browser is received.

The user identification information herein can be a string information, a sliding trajectory input by a gesture operation, or the like.

At step 102, it is checked whether the user identification information is matched with a prestored user identification information.

Preferably, when the user identification information is the string information, it can be checked whether the user identification information is the same as the prestored user identification information; when the user identification information is the sliding trajectory input by a gesture operation, a match degree between the user identification information and the prestored user identification information can be checked.

At step 103, the private browsing mode of the browser is enabled if the checking result is that the user identification information is matched with the prestored user identification information.

Preferably, when the user identification information is the string information, if it is checked that the user identification information is the same as the prestored user identification information, the checking result is that the user identification information is matched with the prestored user identification information; when the user identification information is the sliding trajectory input by a gesture operation, if it is checked that the match degree between the user identification information and the prestored user identification information is larger than a predetermined threshold, the checking result is that the user identification information is matched with the prestored user identification information.

In conclusion, according to the method for enabling private browsing provided in the first embodiment of the present disclosure, the private browsing mode of the browser can be used only when a legitimate user inputs a correct user identification information, thereby it is avoided that other users perform operations which infringe on the legitimate user's rights and interests or privacy through the private browsing mode of the browser, so that security risks are greatly reduced.

### Second Embodiment

Please refer to FIG. 2, which shows a flowchart of a method for enabling private browsing provided in the second embodiment of the present disclosure. The method for enabling private browsing can be applied to an electronic device containing a browser, and the method for enabling private browsing can include the flowing steps 201-210.

At step 201, an identity authentication information is received, which is used for verifying whether a user has a permission to set the user identification information for enabling a private browsing mode of the browser.

Before the user identification information is set, in order to ensure the safety of a user's privacy, only the user who possesses the electronic device can set the user identification information. Of course, the user who possesses the electronic device can also input the identity authentication information at first, and then let other users set their own user identification information, in order for the private browsing mode of the browser to be enabled by the user identification information defined by their own.

The identity authentication information can be any information known only by the user who possesses the electronic device, to verify whether a user has a permission to set the user identification information for enabling a private browsing mode of the browser. For example, the identity authentication information can be an authentication information authorized to the user who possesses the electronic device by the merchant of the browser, or can be the information set by the user who possesses the electronic device himself.

At step 202, it is checked whether the received identity authentication information is matched with prestored identity authentication information.

At step 203, if the checking result is that the received identity authentication information is matched with the prestored identity authentication information, user identification information for enabling the private browsing mode of the browser is received and saved, so that the user identification information is taken as the prestored user identification information.

Similarly with the first embodiment, the user identification information can be a string information, a sliding trajectory input by a gesture operation, or the like.

The string information can be information composed of characters such as letters, digits, and/or symbols.

The sliding trajectory input by a gesture operation can be one or more straight-line trajectories, one or more broken-line trajectories, one or more curve trajectories, and so on. Of course, the sliding trajectory can also carry direction information. For example, the sliding trajectory may be a trajectory generated when sliding from the bottom up, a trajectory generated when sliding from the left to the right, and so on. The present disclosure does not limit the specific forms of the sliding trajectory.

At step 204, a trigger signal for enabling the private browsing mode of the browser is received.

When a user wants to enable the private browsing mode of the browser, he can click an icon for the private browsing mode on the browser to produce a trigger signal for enabling the private browsing mode of the browser. Accordingly, the electronic device can receive a trigger signal for enabling the private browsing mode of the browser.

At step 205, after the trigger signal is received, a graphical interface for inputting the user identification information is displayed.

After receiving the trigger signal, the electronic device containing a browser can display the graphical interface for inputting the user identification information on an interface of the electronic device.

The graphical interface can be displayed as different interfaces according to the user's requirements; for example, it can be displayed as an interface displaying multiple characters requiring the user to form the user identification information according to a selection of the characters, can be displayed as an interface having multiple points requiring the user to form the user identification information having a sliding trajectory according to the connection between two or more points, can be displayed as an interface displaying predetermined multiple trajectories requiring the user to form the user identification information by sliding according to one or more trajectories thereof, can be displayed as an interface having no information displayed thereon requiring the user to draw by hand arbitrarily on the interface to form the user identification information, and so on. The present disclosure does not limit the specific forms of the graphical interface, and it suffices that the graphical interface can be used to input the user identification information.

At step 206, the user identification information is received on the graphical interface. The user identification information can be a string information, a sliding trajectory input by a gesture operation, or the like.

The user identification information can be a string information. For example, the string information can be information composed of characters such as letters, digits, and/or symbols. For example, the string information can be 1234, 1234abcd, 1a2+b3, or the like.

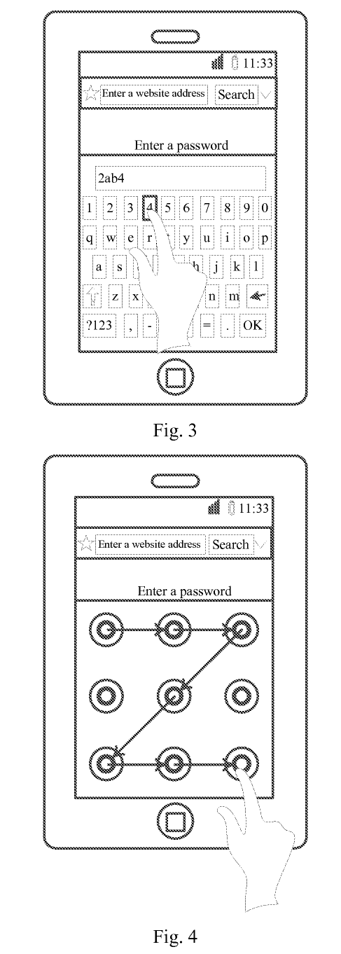

Please refer to FIG. 3, which shows a schematic diagram of inputting the user identification information in one embodiment of the present disclosure. When the user is required to input the user identification information, a graphical interface containing multiple characters is displayed on the screen. The user can select the characters on the interface as needed to form a string password. The first four characters of the character password in the figure are 2ab4.

The user identification information can also be a sliding trajectory input by a gesture operation, for example, a trajectory by sliding according to a customized rule, or a trajectory input arbitrarily by a gesture operation.

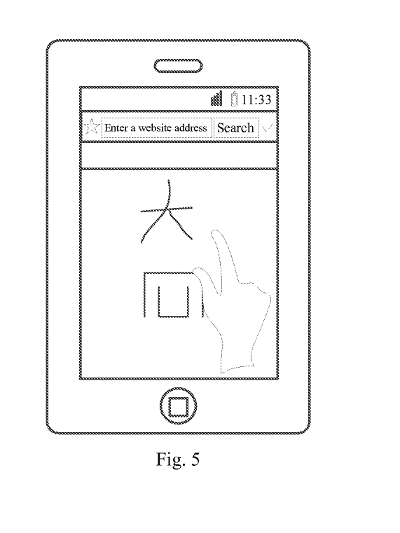

Please refer to FIG. 4, which shows a schematic diagram of inputting the user identification information in another embodiment of the present disclosure. Nine points in three rows and three columns are set on the graphical interface. The trajectory generated by connecting different points by sliding in accordance with a customized rule is the user identification information. The formation procedure of the trajectory as shown in the figure is as follows. At first, three points in the first row are connected from the left to the right. Then, the middle point in the second row is connected. Subsequently, the leftmost point in the third row is connected. Finally, three points in the third row are connected from the left to the right.

Please refer to FIG. 5, which shows a schematic diagram of inputting the user identification information in a further embodiment of the present disclosure. The user may draw any character or graph by hand on the graphical interface, for example, the Chinese character “ [symbol] ” as shown in the figure or the multiple broken lines as shown in the figure. In the practical application, the user can write only characters such as Chinese characters, Japanese characters, Korean characters, English characters or the like by hand on the graphical interface, draw graphs such as circles, straight lines, broken lines, flowers and grasses or the like by hand, or draw characters and graphs by hand simultaneously on the same graphical interface.

At step 207, it is checked whether the user identification information is matched with the prestored user identification information.

For example, when the user identification information is the string information, it is checked whether the user identification information is the same as the prestored user identification information.

For example, when the user identification information is a sliding trajectory input by a gesture operation, the match degree between the user identification information and the prestored user identification information is checked.

At step 208, the private browsing mode of the browser is enabled if the checking result is that the user identification information is matched with the prestored user identification information.

For example, when the user identification information is the string information, if it is checked that the user identification information is the same as the prestored user identification information, the checking result is that the user identification information is matched with the prestored user identification information.

For example, when the user identification information is a sliding trajectory input by a gesture operation, if it is checked that the match degree between the user identification information and the prestored user identification information is larger than a predetermined threshold, the checking result is that the user identification information is matched with the prestored user identification information.

It should be noted that, when the sliding trajectory obtained according to a certain predetermined rule is unique, it could still be checked whether the user identification information is the same as the prestored user identification information. For example, the line formed by connecting the points in FIG. 4 can be considered unique user identification information. However, when the sliding trajectory obtained according to a certain predetermined rule may not be unique, a suitable predetermined threshold can be set to determine the matching between the user identification information and the prestored user identification information. For example, when the sliding trajectory is a trajectory generated by an operation where the user uses three fingers to slide from the bottom up on the graphical interface, the distances between the three fingers may be different each time the user performs sliding, and the lengths of sliding may be different and the sliding positions on the graphical interface may be different. However, as long as the electronic device acquires three trajectories of sliding from the bottom up on the graphical interface, it can be considered that the user identification information formed by the three trajectories is matched with the prestored user identification information.

At step 209, request information for saving a bookmark is received.

When it is checked that the user identification information received on the graphical interface is correct, the private browsing mode of the browser is enabled. In the private browsing mode, the browser does not record browsing records, search histories, cookies, cached files and so on of the user. However, when the user wants to save a certain bookmark in the private browsing mode to browse directly through the bookmark when next entering the private browsing mode, the private browsing mode of the browser can receive the request information when the user saves the bookmark.

At step 210, after the request information is received, the bookmark is saved in the private browsing mode to display the bookmark after the private browsing mode is enabled next time.

After receiving the request information of the user saving a bookmark, the electronic device would save the corresponding bookmark in the private browsing mode to display the bookmark after the private browsing mode is enabled next time.

In one embodiment, when the number of pieces of saved user identification information is two or more, that is, multiple legitimate users can all use the private browsing mode, in order to ensure privacy among respective legitimate users. The process whereby the electronic device saves a bookmark in the private browsing mode corresponding to each piece of user identification information to display the bookmark after the private browsing mode is enabled next time can include saving a bookmark in the private browsing mode corresponding to the user identification information so as to display the bookmark after the private browsing mode is enabled through the user identification information next time.

That is to say, when a certain user enters the private browsing mode through user identification information A, the bookmark P that is requested by the user to be saved is saved only in the private browsing mode corresponding to user identification information A. The user can see the bookmark P after entering the private browsing mode through user identification information A next time. When another user enters the private browsing mode through user identification information B, the bookmark Q that is requested by said other user to be saved is saved only in the private browsing mode corresponding to the user identification information B. Said other user can see the bookmark Q after entering the private browsing mode through the user identification information B next time. The user entering the private browsing mode through user identification information A fails to see the bookmark Q. Similarly, said other user entering the private browsing mode through user identification information B fails to see the bookmark P.

In conclusion, in the method for enabling private browsing provided in the second embodiment of the present disclosure, the icon for the private browsing mode on the interface of the browser is selected to input the user identification information, and the private browsing mode of the browser can be used only when a legitimate user inputs correct user identification information; thereby, it is avoided that other users perform operations which infringe on the legitimate user's rights and interests or privacy through the private browsing mode of the browser, so that security risks are greatly reduced.

It should be noted that, in the second embodiment, the performance order of steps 201-203 and steps 204-206 is not necessary to follow a fixed sequence. Steps 204-206 can be performed after the steps 201-203. However, in the solution of the second embodiment, steps 201-203 and steps 204-206 may be performed multiple times according to operations of the user. Thus, according to the operations of the user, one performance of steps 201-203 may be after one performance of steps 204-206. Therefore, the order of respective process blocks in FIG. 2 does not limit the present disclosure. Additionally, steps 201-203 may be applied likewise to the first embodiment. Further, steps 209-210 are not necessary steps of the second embodiment, that is, the object of the present disclosure may be realized even if steps 209-210 are omitted from FIG. 2, and steps 209-210 may be preferably applied to the first embodiment likewise.

### Third Embodiment

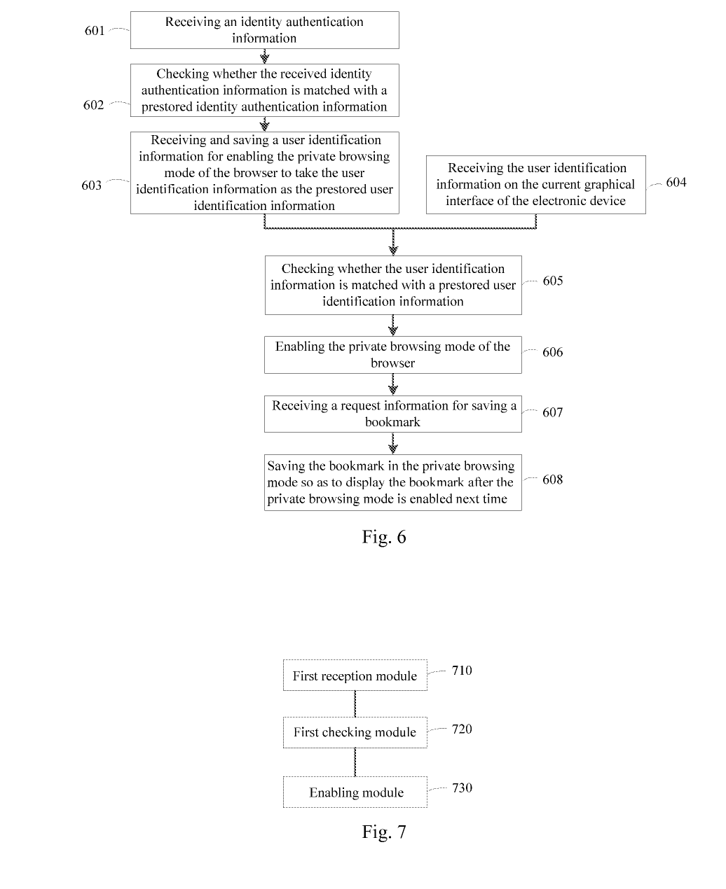

Please refer to FIG. 6, which shows a flowchart of a method for enabling private browsing provided in the third embodiment of the present disclosure. The method for enabling private browsing may be applied to an electronic device containing a browser, and the method for enabling private browsing can include the flowing steps 601-608.

At step 601, identity authentication information is received, which is used for verifying whether a user has permission to set the user identification information for enabling a private browsing mode of the browser.

Before the user identification information is set, in order to ensure the safety of a user's privacy, only the user who possesses the electronic device can set the user identification information. Of course, the user who possesses the electronic device can also input the identity authentication information at first, and then let other users set their own user identification information, in order for the private browsing mode of the browser to be enabled by the user identification information defined by their own.

The identity authentication information can be any information known only by the user who possesses the electronic device, to verify whether a user has permission to set the user identification information for enabling a private browsing mode of the browser. For example, the identity authentication information can be authentication information authorized to the user who possesses the electronic device by the merchant of the browser, or can be the information set by the user who possesses the electronic device himself.

At step 602, it is checked whether the received identity authentication information is matched with a prestored identity authentication information.

At step 603, if the checking result is that the received identity authentication information is matched with the prestored identity authentication information, a user identification information for enabling the private browsing mode of the browser is received and saved, so that the user identification information is taken as the prestored user identification information.

The user identification information can be a sliding trajectory input by a gesture operation. For example, the sliding trajectory can be one or more straight-line trajectories, one or more broken-line trajectories, one or more curve trajectories, and so on. Of course, the sliding trajectory can also carry direction information. For example, the sliding trajectory can be a trajectory generated when sliding from the bottom up, a trajectory generated when sliding from the left to the right, or the like.

At step 604, the user identification information is received on the current graphical interface of the electronic device. The user identification information is a sliding trajectory input by a gesture operation.

The user can slide directly on the current graphical interface to set the user identification information. For example, the user can slide from the bottom up of the current graphical interface through three fingers directly on the current graphical interface, or the like.

A practical application scenario for specific implementation can be as follows. After opening the browser, the user inputs the user identification information directly on the screen, for example, slides from the bottom up directly through three fingers. If the user identification information is correct, the private browsing mode of the browser can be entered directly without needing to find the icon for the private browsing mode on the interface of the browser and then selecting the icon for the private browsing mode, thus the enabling procedure of the private browsing mode is greatly simplified.

At step 605, it is checked whether the user identification information is matched with the prestored user identification information.

For example, when the user identification information is a sliding trajectory input by a gesture operation, the match degree between the user identification information and the prestored user identification information is checked.

At step 606, the private browsing mode of the browser is enabled if the checking result is that the user identification information is matched with the prestored user identification information.

For example, when the user identification information is a sliding trajectory input by a gesture operation, if it is checked that the match degree between the user identification information and the prestored user identification information is larger than a predetermined threshold, the checking result is that the user identification information is matched with the prestored user identification information.

It should be noted that, when the sliding trajectory obtained according to a certain predetermined rule is unique, it could still be checked whether the user identification information is the same as the prestored user identification information. For example, the line formed by connecting the points in FIG. 4 can be considered unique user identification information. However, when the sliding trajectory obtained according to a certain predetermined rule may not be unique, a suitable predetermined threshold can be set to determine the matching between the user identification information and the prestored user identification information. For example, when the sliding trajectory is a trajectory generated by an operation whereby the user uses three fingers to slide from the bottom up on the graphical interface, the distances between the three fingers may be different each time the user performs sliding, the lengths of sliding may be different, and the sliding positions on the graphical interface may be different. However, as long as the electronic device acquires three trajectories of sliding from the bottom up on the graphical interface, it can be considered that the user identification information formed by the three trajectories is matched with the prestored user identification information.

At step 607, request information for saving a bookmark is received.

When it is checked that the user identification information received on the graphical interface is correct, the private browsing mode of the browser is enabled. In the private browsing mode, the browser does not record browsing records, search histories, cookies, cached files and so on of the user. However, when the user wants to save a certain bookmark in the private browsing mode to browse directly through the bookmark when next entering the private browsing mode, the private browsing mode of the browser can receive the request information when the user saves the bookmark.

At step 608, after the request information is received, the bookmark is saved in the private browsing mode to display the bookmark after the private browsing mode is enabled next time.

After receiving the request information of the user saving a bookmark, the electronic device would save the corresponding bookmark in the private browsing mode to display the bookmark after the private browsing mode is enabled next time.

In a preferable embodiment, when the number of pieces of saved user identification information is two or more, that is, multiple legitimate users can all use the private browsing mode, in order to ensure privacy among respective legitimate users, the process whereby the electronic device saves a bookmark in the private browsing mode so as to display the bookmark after the private browsing mode is enabled next time can include saving a bookmark in the private browsing mode corresponding to the user identification information so as to display the bookmark after the private browsing mode is enabled through the user identification information next time.

That is to say, when a certain user enters the private browsing mode through user identification information A, the bookmark P that is requested by the user to be saved is saved only in the private browsing mode corresponding to user identification information A. The user can see the bookmark P after entering the private browsing mode through user identification information A next time. When another user enters the private browsing mode through user identification information B, the bookmark Q that is requested by said other user to be saved is saved only in the private browsing mode corresponding to user identification information B. Said other user can see the bookmark Q after entering the private browsing mode through user identification information B next time. The user entering the private browsing mode through user identification information A fails to see the bookmark Q. Similarly, said other user entering the private browsing mode through user identification information B fails to see the bookmark P.

In conclusion, in the method for enabling private browsing provided in the third embodiment of the present disclosure, correct user identification information can be directly input on the interface of the browser to enter the private browsing mode of the browser, and the private browsing mode of the browser can be used only when a legitimate user inputs the correct user identification information, thereby it is avoided that other users perform operations which infringe on the legitimate user's rights and interests or privacy through the private browsing mode of the browser, so that security risks are greatly reduced.

Similarly with the second embodiment, in the third embodiment, the performance order of steps 601-603 and step 604 is not necessary to follow a fixed sequence. Step 604 can be performed after steps 601-603. However, in the solution of the third embodiment, steps 601-603 and step 604 may be performed multiple times according to operations of the user. Thus, according to the operations of the user, one performance of steps 601-603 may be after one performance of step 604. Therefore, the order of respective process blocks in FIG. 6 does not limit the present disclosure. Further, steps 607-608 are not necessary steps but preferable steps of the third embodiment.

### Fourth Embodiment

Please refer to FIG. 7, which shows a structural schematic diagram of an apparatus for enabling private browsing provided in a fourth embodiment of the present disclosure. The apparatus for enabling private browsing may be implemented as part of an electronic device containing a browser or part of a browser. The apparatus for enabling private browsing can include a first reception module 710, a first checking module 720, and an enabling module 730.

The first reception module 710 can be configured to receive user identification information for enabling a private browsing mode of the browser.

The first checking module 720 can be configured to check whether the user identification information received by the first reception module 710 is matched with a prestored user identification information.

The enabling module 730 can be configured to enable the private browsing mode of the browser if the checking result of the first checking module 720 is that the user identification information is matched with the prestored user identification information.

In conclusion, according to the apparatus for enabling private browsing provided in the fourth embodiment of the present disclosure, the private browsing mode of the browser can be used only when a legitimate user inputs the correct user identification information, thereby it is avoided that other users perform operations which infringe on the legitimate user's rights and interests or privacy through the private browsing mode of the browser, so that security risks are greatly reduced.

### Fifth Embodiment

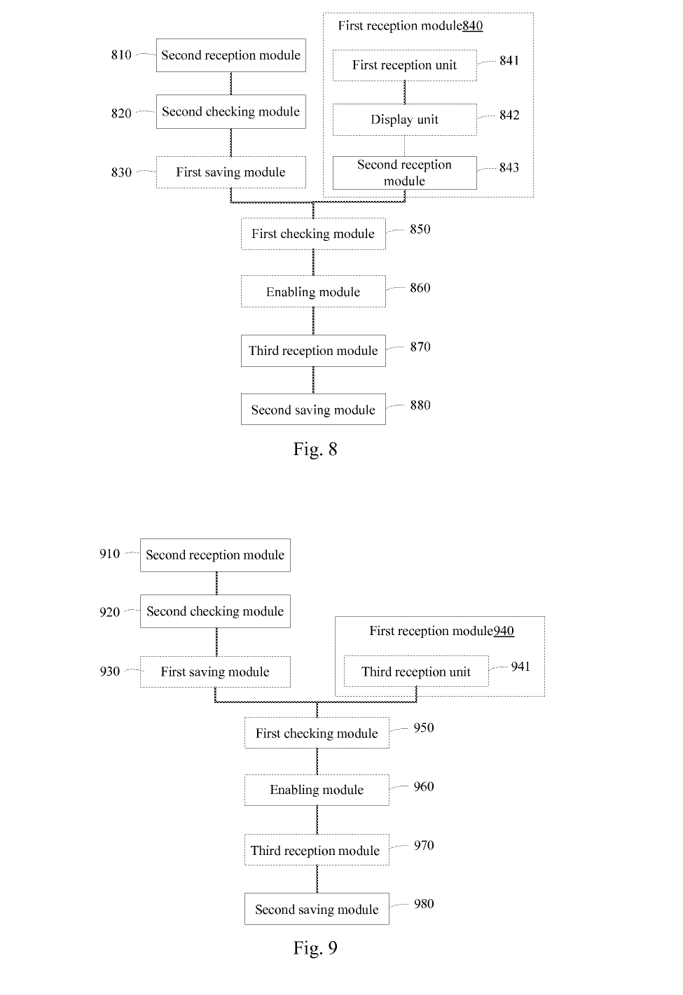

Please refer to FIG. 8 which shows a structural schematic diagram of an apparatus for enabling private browsing provided in a fifth embodiment of the present disclosure. The apparatus for enabling private browsing can be implemented as part of an electronic device containing a browser or part of a browser. The apparatus for enabling private browsing can include a second reception module 810, a second checking module 820, a first saving module 830, a first reception module 840, a first checking module 850, and an enabling module 860, and can preferably include a third reception module 870 and a second saving module 880.

The second reception module 810 can be configured to receive identity authentication information, which is used for verifying whether a user has permission to set the user identification information for enabling a private browsing mode of the browser.

The second checking module 820 can be configured to check whether the identity authentication information received by the second reception module 810 is matched with the prestored identity authentication information.

The first saving module 830 can be configured to receive and save user identification information for enabling the private browsing mode of the browser to take the user identification information as the prestored user identification information when the checking result of the second checking module 820 is that the received identity authentication information is matched with the prestored identity authentication information.

The first reception module 840 can be configured to receive the user identification information for enabling the private browsing mode of the browser.

In one preferable embodiment, the first reception module 840 can include a first reception unit 841, a display unit 842 and a second reception unit 843.

The first reception unit 841 can be configured to receive a trigger signal for enabling the private browsing mode of the browser.

The display unit 842 can be configured to display a graphical interface for inputting the user identification information after the trigger signal is received by the first reception unit 841.

The second reception unit 843 can be configured to receive the user identification information on the graphical interface displayed by the display unit 842. The user identification information can be a string information, a sliding trajectory input by a gesture operation, or the like.

The first checking module 850 can be configured to check whether the user identification information received by the first reception module 840 is matched with the prestored user identification information.

In one preferable embodiment, the first checking module 850 can be configured to check whether the user identification information received by the second reception unit 843 is matched with the user identification information saved by the first saving module 830.

The enabling module 860 can be configured to enable the private browsing mode of the browser when the checking result of the first checking module 850 is that the user identification information is matched with the prestored user identification information.

The third reception module 870 can be configured to receive request information for saving a bookmark.

In one preferable embodiment, the third reception module 870 can be configured to receive the request information for saving a bookmark in the private browsing mode of the browser enabled by the enabling module 860.

The second saving module 880 can be configured to save the bookmark in the private browsing mode after the request information is received by the third reception module 870 to display the bookmark after the private browsing mode is enabled next time.

In one preferable embodiment, when the first saving module 830 saves two or more pieces of user identification information, the second saving module 880 can be configured to save the bookmark in the private browsing mode corresponding to the user identification information so as to display the bookmark after the private browsing mode is enabled through the user identification information next time.

In conclusion, in the apparatus for enabling private browsing provided in the fifth embodiment of the present disclosure, the icon for the private browsing mode on the interface of the browser is selected to input the user identification information, and the private browsing mode of the browser can be used only when a legitimate user inputs the correct user identification information, thereby it is avoided that other users perform operations which infringe on the legitimate user's rights and interests or privacy through the private browsing mode of the browser, so that security risks are greatly reduced.

### Sixth Embodiment

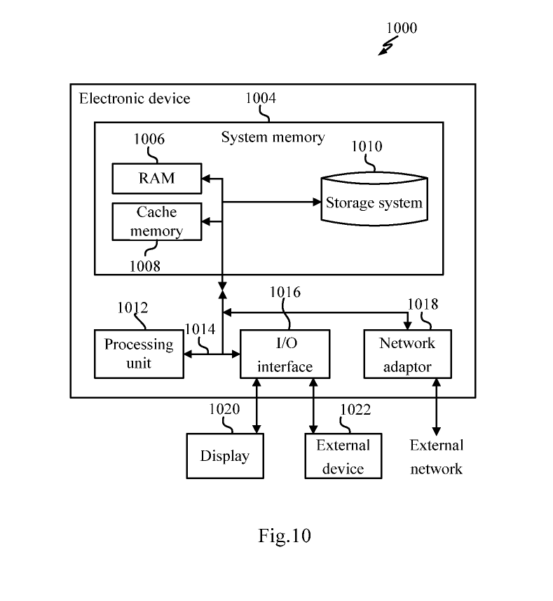

Please refer to FIG. 9, which shows a structural schematic diagram of an apparatus for enabling private browsing provided in a sixth embodiment of the present disclosure. The apparatus for enabling private browsing can be implemented as part of an electronic device containing a browser, or part of a browser. The apparatus for enabling private browsing can include a second reception module 910, a second checking module 920, a first saving module 930, a first reception module 940, a first checking module 950, and an enabling module 960, and may preferably include a third reception module 970 and a second saving module 980.

The second reception module 910 can be configured to receive identity authentication information, which is used for verifying whether a user has permission to set the user identification information for enabling a private browsing mode of the browser.

The second checking module 920 can be configured to check whether the identity authentication information received by the second reception module 910 is matched with the prestored identity authentication information.

The first saving module 930 can be configured to receive and save user identification information for enabling the private browsing mode of the browser to take the user identification information as the prestored user identification information when the checking result of the second checking module 920 is that the received identity authentication information is matched with the prestored identity authentication information.

The first reception module 940 can be configured to receive the user identification information for enabling the private browsing mode of the browser.

In one preferable embodiment, the first reception module 940 can include a third reception unit 941.

The third reception unit 941 can be configured to receive user identification information on the current graphical interface of the electronic device. The user identification information is a sliding trajectory input by a gesture operation.

The first checking module 950 can be configured to check whether the user identification information received by the first reception module 940 is matched with the prestored user identification information.

In one preferable embodiment, the first checking module 950 can be configured to check whether the user identification information received by the third reception unit 941 is matched with the user identification information saved by the first saving module 930.

The enabling module 960 can be configured to enable the private browsing mode of the browser when the checking result of the first checking module 950 is that the user identification information is matched with the prestored user identification information.

The third reception module 970 can be configured to receive a request information for saving a bookmark.

In one preferable embodiment, the third reception module 970 can be configured to receive the request information for saving a bookmark in the private browsing mode of the browser enabled by the enabling module 960.

The second saving module 980 can be configured to save the bookmark in the private browsing mode after the request information is received by the third reception module 970 to display the bookmark after the private browsing mode is enabled next time.

In one preferable embodiment, when the first saving module 930 saves two or more pieces of user identification information, the second saving module 980 may be configured to save the bookmark in the private browsing mode corresponding to the user identification information so as to display the bookmark after the private browsing mode is enabled through the user identification information next time.

In conclusion, in the apparatus for enabling private browsing provided in the sixth embodiment of the present disclosure, correct user identification information can be directly input on the interface of the browser to enter the private browsing mode of the browser, and the private browsing mode of the browser can be used only when a legitimate user inputs the correct user identification information, thereby it is avoided that other users perform operations which infringe on the legitimate user's rights and interests or privacy through the private browsing mode of the browser, so that security risks are greatly reduced.

It should be noted that, the apparatuses for enabling private browsing provided in the above embodiments are described when enabling the private browsing mode only by taking the division of above respective functional modules as an example. In a practical application, the above functions may be assigned as needed to different functional modules to be performed, that is, the internal structure of the apparatus for enabling private browsing can be divided into different functional modules to perform all or part of functions as described above. Further, the apparatuses for enabling private browsing provided in the above embodiments and method embodiments for enabling private browsing belong to a same concept, and the specific implementation of the apparatuses can refer to the method embodiments, and unnecessary details will no longer be given here.

The embodiment numbers of the present disclosures as described above are only for the purpose of description and do not represent the inferiority or superiority of the embodiments.

It can be understood by those ordinary skilled in the art that all or part of steps for implementing the above embodiments can be implemented by hardware or by the related hardware instructed by a program which can be stored in a computer readable storage medium which may be a read only memory, a disk, a compact disc or the like. For example, the present disclosure may be implemented as a computer readable storage medium having stored thereon a computer program containing a program code which, when executed on a computing device, performs respective steps of the method for enabling private browsing as described above.

FIG. 10 is a structural schematic diagram showing an exemplary electronic device which can be used to implement respective embodiments of the present disclosure.

The electronic device 1000 shown in FIG. 10 is only an example and is not limiting of the functionality and the scope of use of embodiments of the disclosure. As shown in FIG. 10, the electronic device 1000 may be in a form of a general purpose computing device. Components of the electronic device 1000 may include, but are not limited to, one or more processors or processing units 1012, a system memory 1004, an I/O interface 1016, a network adapter 1018, a display 1020, and a bus 1014 that couples various components, and may be connected to an external device 1022.

The bus 1014 represents one or more of several types of bus structures. For example, such bus structures include, but are not limited to, Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, and so on.

The electronic device 1000 typically includes a variety of computer system readable media. Such media may be any readable media that is accessible by the electronic device 1000, and it includes both volatile and non-volatile media, and both removable and non-removable media.

The system memory 1004 can include readable media in the form of volatile memory, such as random access memory (RAM) 1006 and/or cache memory 1008. The electronic device 1000 may further include other removable/non-removable, volatile/non-volatile storage media. For example, the storage system 1010 (typically called a “hard drive”) can be provided for reading from and writing to a non-removable, non-volatile magnetic media. Although not shown, a magnetic disk drive for reading from and writing to a removable, non-volatile magnetic disk (e.g., a “U disk”), and an optical disk drive for reading from or writing to a removable, non-volatile optical disk such as a CD-ROM, DVD-ROM or other optical media can be provided. In such instances, each drive can be connected to the bus 1014 by one or more data medium interfaces.

The system memory 1004 may include at least one program product having a set (for example, at least one) of program modules, which may be stored in the storage system 1010. The program module contains a computer executable program instruction. Such program modules are configured to perform functions of respective embodiments of the present disclosure by the processing units 1012 executing the program instruction therein. Such program modules include, but are not limited to, an operating system, one or more application programs, other program modules, and program data. Each of these examples of program modules or some combination thereof may include an implementation of a networking environment.

The electronic device 1000 may also communicate with one or more external devices 1022 such as a keyboard, a mouse, the display 1020, etc.; and one or more devices that enable a user to interact with the electronic device 1000. Such communication can occur via the Input/Output (I/O) interface 1016. Further, the electronic device 1000 can also communicate with one or more networks such as a local area network (LAN), a general wide area network (WAN), and/or a public network (e.g., the Internet) via the network adapter 1018 such as a network card, modem, etc. As shown in FIG. 10, the I/O interface 1016 and the network adapter 1018 communicates with the other modules of the electronic device 1000 via the bus 1014. It should be understood that, although not shown, other hardware and/or software modules could be used in conjunction with the electronic device 1000. Such other hardware and/or software modules include, but are not limited to microcode, device drivers, redundant processing units, external disk drive arrays, RAID systems, tape drives, and data archival storage systems, etc.

Respective units or steps in respective embodiments of the present disclosure may all be implemented by executing program modules having computer program instructions in the electronic device 1000.

The described above is only preferable embodiments of the present disclosure and is not intended to limit the present disclosure. Any modification, equivalent replacement, improvement, etc made within the spirit and principle of the present disclosure should all be contained within the protection scope of the present disclosure.

What is claimed is:

1. A method for enabling private browsing on an electronic device containing a browser, comprising:
receiving a user identification information for enabling a private browsing mode of the browser;
checking whether the user identification information matches with a prestored user identification information; and
if the checking results in a the user identification information matching with the prestored user identification information, enabling the private browsing mode of the browser.

2. The method of claim 1, wherein said receiving the user identification information for enabling the private browsing mode of the browser comprises:
receiving a trigger signal for enabling the private browsing mode of the browser;
displaying a graphical interface for inputting the user identification information after receiving the trigger signal; and
receiving the user identification information on the graphical interface, the user identification information being a string information or a sliding trajectory input by a gesture operation.

3. The method of claim 1, wherein said receiving the user identification information for enabling the private browsing mode of the browser comprises:
receiving the user identification information on the current graphical interface of the electronic device, the user identification information being a sliding trajectory input by a gesture operation.

4. The method of claim 1, before said receiving the user identification information for enabling the private browsing mode of the browser, further comprising:
receiving an identity authentication information for verifying whether a user has a permission to set the user identification information for enabling the private browsing mode of the browser;
checking whether the received identity authentication information is matched with a prestored identity authentication information; and
receiving and saving a user identification information for enabling the private browsing mode of the browser to take the user identification information as the prestored user identification information if the checking result is that the received identity authentication information is matched with the prestored identity authentication information.

5. The method of claim 1, further comprising:
receiving a request information for saving a bookmark; and
saving the bookmark in the private browsing mode after receiving the request information so as to display the bookmark after the private browsing mode is enabled next time.

6. The method of claim 5, wherein when two or more pieces of the user identification information are saved, said saving the bookmark in the private browsing mode so as to display the bookmark after the private browsing mode is enabled next time comprises:
saving the bookmark in the private browsing mode corresponding to the user identification information so as to display the bookmark after the private browsing mode is enabled through the user identification information next time.

7. An apparatus for enabling private browsing which is applied to an electronic device containing a browser, comprising:
a first reception module configured to receive a user identification information for enabling a private browsing mode of the browser;
a first checking module configured to check whether the user identification information received by the first reception module is matched with a prestored user identification information; and
an enabling module configured to enable the private browsing mode of the browser when the checking result of the first checking module is that the user identification information is matched with the prestored user identification information.

8. The apparatus of claim 7, wherein the first reception module comprises:
a first reception unit configured to receive a trigger signal for enabling the private browsing mode of the browser;
a display unit configured to display a graphical interface for inputting the user identification information after the trigger signal is received by the first reception unit; and
a second reception unit configured to receive the user identification information on the graphical interface displayed by the display unit, the user identification information being a string information or a sliding trajectory input by a gesture operation.

9. The apparatus of claim 7, wherein the first reception module comprises:
a third reception unit configured to receive the user identification information on the current graphical interface of the electronic device, the user identification information being a sliding trajectory input by a gesture operation.

10. The apparatus of claim 7, further comprising:
a second reception module configured to receive an identity authentication information which is used for verifying whether a user has a permission to set the user identification information for enabling the private browsing mode of the browser;
a second checking module configured to check whether the identity authentication information received by the second reception module is matched with a prestored identity authentication information; and
a first saving module configured to receive and save a user identification information for enabling the private browsing mode of the browser to take the user identification information as the prestored user identification information when the checking result of the second checking module is that the received identity authentication information is matched with the prestored identity authentication information.

11. The apparatus of claim 7, further comprising:
a third reception module configured to receive a request information for saving a bookmark; and
a second saving module configured to save the bookmark in the private browsing mode after the request information is received by the third reception module so as to display the bookmark after the private browsing mode is enabled next time.

12. The apparatus of claim 11, wherein when two or more pieces of the user identification information are saved by the first saving module, said second saving module is configured to:
save the bookmark in the private browsing mode corresponding to the user identification information so as to display the bookmark after the private browsing mode is enabled through the user identification information next time.

13. An electronic device containing a browser, the electronic device comprising an apparatus for enabling private browsing, and the apparatus comprising:
a first reception module configured to receive a user identification information for enabling a private browsing mode of the browser;
a first checking module configured to check whether the user identification information received by the first reception module is matched with a prestored user identification information; and
an enabling module configured to enable the private browsing mode of the browser when the checking result of the first checking module is that the user identification information is matched with the prestored user identification information.

14. The electronic device of claim 13, wherein the first reception module comprises:
a first reception unit configured to receive a trigger signal for enabling the private browsing mode of the browser;
a display unit configured to display a graphical interface for inputting the user identification information after the trigger signal is received by the first reception unit; and
a second reception unit configured to receive the user identification information on the graphical interface displayed by the display unit, the user identification information being a string information or a sliding trajectory input by a gesture operation.

15. The electronic device of claim 13, wherein the first reception module comprises:
a third reception unit configured to receive the user identification information on the current graphical interface of the electronic device, the user identification information being a sliding trajectory input by a gesture operation.

16. The electronic device of claim 13, further comprising:
a second reception module configured to receive an identity authentication information which is used for verifying whether a user has a permission to set the user identification information for enabling the private browsing mode of the browser;
a second checking module configured to check whether the identity authentication information received by the second reception module is matched with a prestored identity authentication information; and
a first saving module configured to receive and save a user identification information for enabling the private browsing mode of the browser to take the user identification information as the prestored user identification information when the checking result of the second checking module is that the received identity authentication information is matched with the prestored identity authentication information.

17. The electronic device of claim 13, further comprising:
a third reception module configured to receive a request information for saving a bookmark; and
a second saving module configured to save the bookmark in the private browsing mode after the request information is received by the third reception module so as to display the bookmark after the private browsing mode is enabled next time.

18. The electronic device of claim 13, wherein when two or more pieces of the user identification information are saved by the first saving module, said second saving module is configured to:
save the bookmark in the private browsing mode corresponding to the user identification information so as to display the bookmark after the private browsing mode is enabled through the user identification information next time.
